(19) United States
(12) Patent Application Publication
(10) Pub. No.: US 2008/0136903 A1
(43) Pub. Date: Jun. 12, 2008

(54) ENDOSCOPE

(76) Inventors: Toshio Takada, Kurokawa-gun (JP); Jun Hasegawa, Kurokawa-gun (JP)

Correspondence Address: BIRCH STEWART KOLASCH & BIRCH, PO BOX 747, FALLS CHURCH, VA, 22040-0747, US

(21) Appl. No.: 11/940,163

(22) Filed: Nov. 14, 2007

(30) Foreign Application Priority Data
Nov. 17, 2006 (JP) P2006-311314
Nov. 17, 2006 (JP) P2006-311315

(51) Int. Cl. H04N 7/18

(52) U.S. Cl. 348/65; 348/E07.085

(57) ABSTRACT

An endoscope includes an electronic endoscope unit 50 and an external control unit 30 for transmitting and receiving a signal to and from the electronic endoscope unit 50. The electronic endoscope unit 50 includes a front end section 10 having an imaging element 11 and a cable 20 housing a wire for connecting the front end section 10 to the external control unit 30. The front end section 10 includes a CDS circuit 12 for performing a correlated-double sampling process for an analog signal output from the imaging element 11 and an A/D converter 14 for converting the analog signal subject to the correlated-double sampling process into a digital signal.

### CROSS-REFERENCE TO RELATED APPLICATIONS

This application is based upon and claims the benefit of priority from the Japanese Patent Application Nos. 2006-311314 (filed on Nov. 17, 2006) and 2006-311315 (filed on Nov. 17, 2006), the entire contents of which are incorporated herein by reference.

### BACKGROUND OF THE INVENTION

1. Technical Field

The invention relates to an endoscope having an electronic endoscope unit and an external control unit for transmitting and receiving signals to and from the electronic endoscope unit.

2. Description of the Related Art

FIG. 3 is a view showing a schematic configuration of an endoscope according to a comparative example.

The endoscope shown in FIG. 3 includes an endoscope unit 100 to be inserted in a body and an external control unit 400 that transmits and receives signals to and from electric elements of the endoscope unit 100. The endoscope unit 100 is connected to the external control unit 400 through a connector (not shown).

The endoscope unit 100 includes a front end section 200 which has various electric elements such as an imaging element 201 and which is formed in the front end of the endoscope unit 100, and a cable 300 that is a housing portion that houses wires for connecting the electric elements in the front end section 200 to the external control unit 400. Normally, cables 300 having different lengths for respective sites to be observed are prepared, and the length of the cable 300 can be selected in accordance with a site to be observed.

The imaging element 201 includes a plurality of photoelectric conversion elements formed on a surface of a semiconductor substrate, a vertical charge transfer section (VCCD) for transferring, in a vertical direction, charges generated in the plurality of photoelectric conversion elements, a horizontal charge transfer section (HCCD) for transferring the charges, which are transferred by the VCCD, in a horizontal direction perpendicular to the vertical direction, and an output amplifier for outputting signals on the basis of the charges transferred by the HCCD.

The external control unit 400 includes a CDS circuit 401 for performing a correlated-double sampling process for analog imaging signals output from the imaging element 201; a PGA (Programmable Gain Amplifier) 402 for amplifying the output signals from the CDS circuit 401; an A/D converter 403 for converting the output signals from the PGA 402 into digital signals; a signal processor 404 for generating video data by performing a signal process such as a γ correction process and a white balance adjusting process for the digital signals subject to the A/D conversion; a V driving section 406 for inputting, to the VCCD, V driving signals used to drive the VCCD of the imaging element 201; a H driving section 407 for inputting, to the HCCD, H driving signals used to drive the HCCD of the imaging element 201; and a timing generator (TG) 405 for generating timing signals used to determine operation timings of the CDS circuit 401, the V driving section 406, and the H driving section 407 and for inputting the timing signals to the CDS circuit 401, the V driving section 406, and the H driving section 407.

In the CDS circuit 401, the output signals of the imaging element 201 are clamped and signal components containing image information are sampled and held. The clamp and the sample hold are carried out on the basis of the timing signals output from the TG 405. Noises in the imaging signals are satisfactorily reduced by the correlated-double sampling process.

A video based on the video data generated by the signal processor 404 can be checked through a monitor 500 connected to the external control unit 400.

In order for the CDS 401 to clamp, sample and hold the imaging signals output from the imaging element 201, it is necessary to perform timing adjustment with high accuracy. However, the length of the cable 300 of the endoscope shown in FIG. 3 is in the range of several tens of cm to several meters, which causes a time delay. For this reason, the timings at which the CDS circuit 401 clamps, holds and samples the imaging signals are shifted. As a result it is not possible to effectively operate the CDS circuit 401.

As shown in FIG. 4, the imaging signals output from the imaging element 201 include a reset pulse part 202, a feed-though part 203, and a data part 204, and have a highly complex curve. As the waveform is repeatedly output at a cycle of several tens of MHz, the bandwidth becomes a broadband. In the configuration shown in FIG. 3, since a distance between the imaging element 201 and the CDS circuit 401 is far away from each other, the configuration shown in FIG. 3 is not suitable for transmitting the broadband imaging signals.

Specifically, since a signal transmission bandwidth becomes narrow due to parasitic components (resistance and capacity) existing in a long transmission line, the feed-through part and the data part of the imaging signals are not flat as shown in FIG. 5. As a result, it is very difficult to adjust timings for the clamping and the sample holding. Furthermore, the correlated-double sampling process may not be carried out accurately because of an influence of a jitter existing in the pulse to be used for the clamping and the sample holding. In recent years, driving speeds of the HCCD and VCCD increase in response to a tendency of a high resolution, and the bandwidth of the imaging signals becomes further broadband. For this reason, it is very important to ensure a signal bandwidth of the transmission line from the imaging element 201 to the CDS circuit 401.

In order to ensure the signal bandwidth, it is desirable to use a configuration disclosed in JP Hei. 3-75118 B. An endoscope disclosed in JP Hei. 3-75118 B includes the CDS circuit 401 built in the front end section 200 shown in FIG. 3. With this configuration, it becomes possible to sufficiently ensure the signal bandwidth.

However, in FIG. 3, even if the front end section 200 includes the CDS circuit 401, the signal quality may be deteriorated during transmission of the imaging signals because the analog imaging signals output from the imaging element 201 are transmitted for a long distance through the cable 300 having a length in the range of several tens of cm to several meters.

Additionally, in FIG. 3, even if the front end section 200 includes the CDS circuit 401, a distance between the horizontal charge transfer section (HCCD) and the H driving section 407 is still away from each other. As a result, the H driving section 407 cannot input H driving signals having a designed waveform to the imaging element 201. Since a rising time and a falling time of the waveform of the H driving signals affect the efficiency of horizontal transfer, the rising time and the falling time are so important. When a distance between the horizontal charge transfer section (HCCD) and the H driving section 407 is away from each other, the parasitic resistance components increase. Accordingly, the waveform of the H driving signals becomes dull and the rising time and the falling time would be delayed. As a result, the transmission efficiency deteriorates.

In order to allow the rising time and falling time of the H driving signals not to be dull, a large-scale H driving section may be used. However, this measure would result in that the circuit increases in size and power consumption increase.

### SUMMARY OF THE INVENTION

The invention has been made in view of the above circumstances and provides an endoscope that is designed to optimally perform the correlated-double sampling process for imaging signals and to prevent the signal quality from deteriorating.

Also, the invention may provide an endoscope that is designed to optimally perform the correlated-double sampling process for the imaging signals, to prevent the charge transfer efficiency from decreasing, and to decrease a size of the endoscope.

[1] According to an aspect of the invention, an endoscope includes an electronic endoscope unit and an external control unit that transmits and receives a signal to and from the electronic endoscope unit. The electronic endoscope unit includes a front end section and a housing section. The front end section has an imaging element. The housing section houses a wire that connects the front end section to the external control unit. The front end section includes a correlated-double sampling processor and an A/D converter. The correlated-double sampling processor performs a correlated-double sampling process for an analog signal output from the imaging element. The A/D converter converts the analog signal to which the correlated-double sampling process is performed, into a digital signal.
[2] In the endoscope of [1], the front end section may further include a first parallel/serial converter and a first transmitter. The first parallel/serial converter converts parallel digital signals of plural bits output from the A/D converter into serial signals. The first transmitter transmits the serial signals to the external control unit through the wire. The external control unit may include a first receiver and a first serial/parallel converter. The first receiver receives the serial signals transmitted from the first transmitter. The first serial/parallel converter restores the digital signals after the AD conversion by converting the serial signals received by the first receiver into parallel signals.
[3] In the endoscope of [1] or [2], the imaging element may include a plurality of photoelectric conversion elements, a vertical charge transfer section and a horizontal charge transfer section. The vertical charge transfer section transfers, in a vertical direction, charges generated in the plurality of photoelectric conversion elements. The horizontal charge transfer section transfers the charges transferred by the vertical charge transfer section, in a horizontal direction perpendicular to the vertical direction. The front end section may further include a horizontal driving unit that drives the horizontal charge transfer section by inputting, to the horizontal charge transfer section, horizontal driving signals of plural phases for driving the horizontal charge transfer section.
[4] In the endoscope of [3], the external control unit may further include a vertical driving unit that drives the vertical charge transfer section by inputting, to the vertical charge transfer section, vertical driving signals for driving the vertical charge transfer section.
[5] In the endoscope of [3] or [4], the external control unit may include a timing signal generator, a second parallel/serial converter and a second transmitter. The timing signal generator generates a plurality of timing signals used to determine timings at which the horizontal driving unit outputs the horizontal driving signals of the plural phases. The second parallel/serial converter converts the plurality of parallel timing signals output from the timing signal generator into serial signals. The second transmitter transmits the serial signals converted by the second parallel/serial converter, to the front end section through the wire. The front end section may further include a second receiver and a second serial/parallel converter. The second receiver receives the serial signals transmitted from the second transmitter. The second serial/parallel converter restores the plurality of timing signals by converting the serial signals received by the second receiver into parallel signals. The horizontal driving unit may output the horizontal driving signals in accordance with the plurality of restored timing signals.
[6] The endoscope of any of [1] to [5], components of the front end section other than the imaging element may be integrated on the same chip.

With the above configuration, it is possible to provide an endoscope that is designed to optimally perform the correlated-double sampling process for the imaging signals and to prevent the signal quality from deteriorating.

[7] According to another aspect of the invention, an endoscope includes an electronic endoscope unit and an external control unit that transmits and receives a signal to and from the electronic endoscope unit. The electronic endoscope unit includes a front end section, a housing section. The front end section has an imaging element. The housing section houses a wire that connects the front end section to the external control unit. The imaging element includes a plurality of photoelectric conversion elements, a vertical charge transfer section and a horizontal charge transfer section. The vertical charge transfer section transfers, in a vertical direction, charges generated in the plurality of photoelectric conversion elements. The horizontal charge transfer section transfers the charges transferred by the vertical charge transfer section in a horizontal direction perpendicular to the vertical direction. The front end section includes a correlated-double sampling processor and a horizontal driving unit. The correlated-double sampling processor performs a correlated-double sampling process for an analog signal output from the imaging element. The horizontal driving unit drives the horizontal charge transfer section by inputting, to the horizontal charge transfer section, horizontal driving signals of plural phases for driving the horizontal charge transfer section. The external control unit includes a vertical driving unit that drives the vertical charge transfer section by inputting, to the vertical charge transfer section through the wire, vertical driving signals for driving the vertical charge transfer section.
[8] In the endoscope of [7], the external control unit may further include a timing signal generator, a parallel/serial converter and a transmitter. The timing signal generator generates a plurality of parallel timing signals used to determine timings at which the horizontal driving unit outputs the horizontal driving signals of the plural phases. The parallel/serial converter that converts the plurality of parallel timing signals into serial signals. The transmitter transmits the serial signals to the front end section through the wire. The front end section may further include a receiver and a serial/parallel converter. The receiver receives the serial signals transmitted from the transmitter. The serial/parallel converter restores the plurality of timing signals by converting the serial signals received by the receiver into parallel signals. The horizontal driving unit outputs the horizontal driving signals in accordance with the plurality of restored timing signals.
[9] In the endoscope of [7] or [8], components of the front end section other than the imaging element may be integrated on the same chip.

With the above configuration, it is possible to provide an endoscope that is designed to optimally perform the correlated-double sampling process for the imaging signals, to prevent the charge transfer efficiency from decreasing, and to decrease a size of the endoscope.

### BRIEF DESCRIPTION OF THE DRAWINGS

FIG. 1 is a view showing a schematic configuration of an endoscope according to a first embodiment.

FIG. 2 is a view showing a schematic configuration of the endoscope according to a second embodiment.

FIG. 3 is a view showing a schematic configuration of the endoscope according to a comparative example.

FIG. 4 is a view showing a waveform of a signal output from an imaging element.

FIG. 5 is a view showing the waveform of the signal output from the imaging element.

FIG. 6 is a view showing a schematic configuration of the endoscope according to a third embodiment.

### DETAILED DESCRIPTION OF EMBODIMENTS OF THE INVENTION

Hereinafter, exemplary embodiments of the invention will be described with reference to the drawings.

### First Embodiment

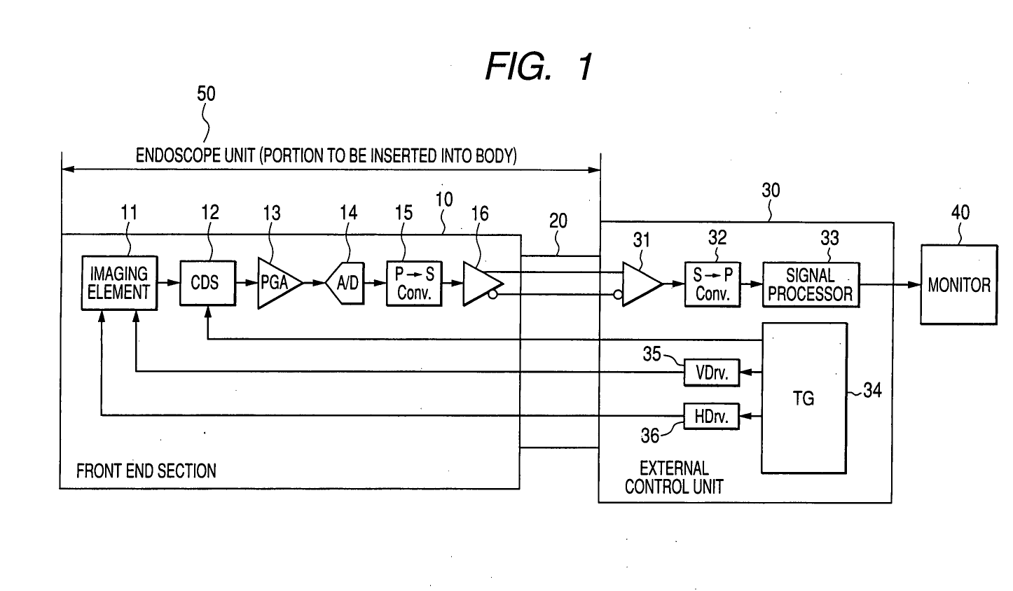

FIG. 1 is a view showing a schematic configuration of an endoscope according to a first embodiment.

The endoscope shown in FIG. 1 includes an endoscope unit 50 to be inserted in a body and an external control unit 30 that transmits and receives signals to and from electric elements of the endoscope unit 50. The endoscope unit 50 is used while being connected to the external control unit 30 through a connector (not shown).

The endoscope unit 50 includes a front end section 10 which is provide a front end of the endoscope unit 50 and which has various electric elements such as an imaging element 11 formed; and a cable 20 that is a housing portion that houses a wire for connecting the electric elements of the front end section 10 to the external control unit 30. cables 20 having different lengths for respective sites to be observed are prepared and the length of the cable 20 can be selected in accordance with a site to be observed. The cable 20 also houses an optical fiber for supplying, to the front end section 10, light illuminating the object to be observed.

The imaging element 11 includes a plurality of photoelectric conversion elements formed on a surface of a semiconductor substrate; vertical charge transfer sections (VCCD) which are disposed on respective sides of the plurality of photoelectric conversion elements and which transfers charges generated in the plurality of photoelectric conversion elements in a vertical direction; a horizontal charge transfer section (HCCD) for transferring the charges transferred by the VCCD in a horizontal direction perpendicular to the vertical direction; and an output amplifier for outputting the charges transferred by the HCCD. The VCCD is driven by, for example, V driving signals of eight phases, and the HCCD is driven by H driving signals of plural phases (for example, four phases).

The front end section 10 includes the imaging element 11; a CDS circuit 12 for performing a correlated-double sampling process for analog imaging signals output from the imaging element 11; a PGA 13 for amplifying output signals of the CDS circuit 12; an A/D converter 14 for converting output signals of the PGA 13 into digital signals of plural bits to parallel output those digital signals; a parallel/serial converter (PS converter) 15 for converting the digital signals of the plural bits output from the A/D converter 14 into serial signals; and a transmitter 16 for transmitting the serial signals converted by the PS converter 15 to the external control unit 30 through a wire.

A distance between the imaging element 11 and the CDS circuit 12 and a distance between the CODS circuit 12 and the A/D converter 14 in the front end section 10 are sufficiently shorter than the length of the cable 20, respectively. The CDS circuit 12 is disposed to be close to the imaging element 11. The A/D converter 14 is disposed to be close to the CDS circuit 12.

In the CDS circuit 12, the output signals of the imaging element 11 are clamped while signal components containing image information are sampled and held. The clamp and the sample hold are carried out on the basis of the timing signals output from a TG 34. Noises in imaging signals are satisfactorily reduced by the correlated-double sampling process.

The transmitter 16 is connected to a receiver 31 of the external control unit 30 through the wire, and transmits the serial signals output from the PS converter 15 to the receiver 31 through the wire on the basis of an LVDS (Low Voltage Differential Signal) technology that is well known as a technology suitable for a long-distance transmission of digital signals. When an impedance value of the receiver 31 is, for example, about 100Ω, it is possible to transmit the signals without deterioration of signal quality, by using a single end cable of 50Ω or a twist bare wire of 100Ω for the wire.

The external control unit 30 includes the receiver 31 which performs communication on the basis of the LDVS technology and which receives the serial signals transmitted from the transmitter 16; a serial/parallel (SP) converter 32 for restores the imaging signals of the plural bits output from the A/D converter 14 by converting the serial signals received by the receiver 31 into parallel signals; and a signal processor 33 for generating video data by performing a digital signal process, such as a γ correction process and a white balance adjusting process, for the imaging signals of the plural bits restored by the SP converter 32.

The video based on the video data generated by the signal processor 33 can be checked through a monitor 40 connected to the external control unit 30.

In addition, the external control unit 30 includes a V driving section 35 for driving the VCCD by inputting, to the VCCD, V driving signals of eight phases used to drive the VCCD of the imaging element 11; a H driving section 36 for driving the HCCD by inputting, to the HCCD, H driving signals of four phases used to drive the HCCD of the imaging element 11; and the timing generator (TG) 34.

The V driving section 35 inputs the V driving signals of eight phases with a predetermined level to driving electrodes of the VCCD at a predetermined timing on the basis of the timing signals output from the TG 34.

The H driving section 36 inputs the H driving signals of four phases with a predetermined level to driving electrodes of the HCCD at a predetermined timing on the basis of the timing signals output from the TG 34.

The TG 34 generates the timing signals used to determine operation timings of the CDS circuit 12, the V driving section 35, and the H driving section 36. Among the timing signals generated by the TG 34, four timing signals corresponding to the H driving signals of four phases to be input from the H driving section 36 to the HCCD are output in parallel, and then input to the H driving section 36. Among the timing signals generated by the TG 34, eight timing signals corresponding to the V driving signals of eight phases to be input from the V driving section 35 to the VCCD are output in parallel, and then input to the V driving section 35.

The CDS circuit 12, the PGA 13, the A/D converter 14, the PS converter 15, and the transmitter 16 are integrated into the same silicon substrate in a form of an integrated IC (Integrated Circuit). Accordingly, decrease in size of the front end section 10 is realized. The IC in the front end section 10 is realized by a general CMOS process.

The receiver 31, the SP converter 32, the TG 34, the V driving section 35, and the H driving section 36 are integrated into the same silicon substrate in a form of an integrated IC. Since the V driving section 35 uses voltages in a range of −8 V to 15 V, the IC in the external control unit 30 cannot be realized by the general CMOS process, and it is necessary to process the IC by a high voltage-endurance CMOS process having a voltage endurance of 30 V or more. Accordingly, the IC in the external control unit 30 is realized by a mixed process of the general CMOS process and the high voltage-endurance CMOS process.

An operation of the endoscope thus configured will be described.

At the time of capturing an image, the timing signals used to determine the driving timings of the VCCD are input to the V driving section 35, and the V driving signals are input from the V driving section 35 to the imaging element 11. In addition, the timing signals used to determine the driving timing of the HCCD are input to the H driving section 36, and the H driving signals are input from the H driving section 36 to the imaging element 11. By the V driving signals and the H driving signals, analog imaging signals corresponding to charges stored in the photoelectric conversion elements during an exposure are output from the imaging element. The imaging signals are subjected to the correlated-double sampling process by the CDS circuit 12, are amplified by the PGA 13, and then are converted into digital signals of plural bits by the A/D converter 14. The digital signals of plural bits are converted into serial signals, and then transmitted from the transmitter 16 to the receiver 31. The serial signals received by the receiver 31 are converted into parallel signals, and then are subjected to various signals processes. Thereafter, an image based on the video data is displayed on the monitor 40.

According to the endoscope having the configuration shown in FIG. 1, since the CDS circuit 12 is provided in the front end section 10 having the imaging element 11 therein, a distance between the imaging element 11 and the CDS circuit 12 is made as short as possible. Accordingly, it is possible to suppress the timing in the CDS circuit 12 for clamping the imaging signals and sampling and holding them from shifting. Thus, it is possible to perform the correlated-double sampling process in an optimum manner.

According to the endoscope having the configuration shown in FIG. 1, since the A/D converter 14 is provided in the front end section 10 having the imaging element 11 therein, a distance for which the analog imaging signals are transmitted is made as short as possible. Accordingly, it is possible to prevent a signal quality from deteriorating due to long-distance transmission of the analog signals.

According to the endoscope having the configuration shown in FIG. 1, the imaging signals of plural bits output from the A/D converter 14 are first converted into the serial signals and then transmitted to the external control unit 30. Therefore, even when the number of bits of the imaging signals output from the A/D converter 14 is any number, the wire for connecting the transmitter 16 to the receiver 31 can be configured of two wires and a diameter of the cable can decrease.

Further, even if the PS converter 15, the transmitter 16, the receiver 31, and the SP converter 32 shown in FIG. 1 are omitted but the A/D converter 14 is directly connected to the signal processor 33 through the wire, the object of the invention can be solved.

### Second Embodiment

In the configuration shown in FIG. 1, since a distance between the imaging element 11 and the V driving section 35 and a distance between the imaging element 11 and the H driving section 36 are away from each other, the VCCD and the HCCD of the imaging element 11 may not be satisfactorily driven due to influences of parasitic components between the imaging element 11 and the V driving section 35 or influences of parasitic components between the imaging element 11 and the H driving section 36. For this reason, in the second embodiment, the V driving section 35 and the H driving section 36 are provided in the front end section 10. Accordingly, the imaging element 11 can be satisfactorily driven.

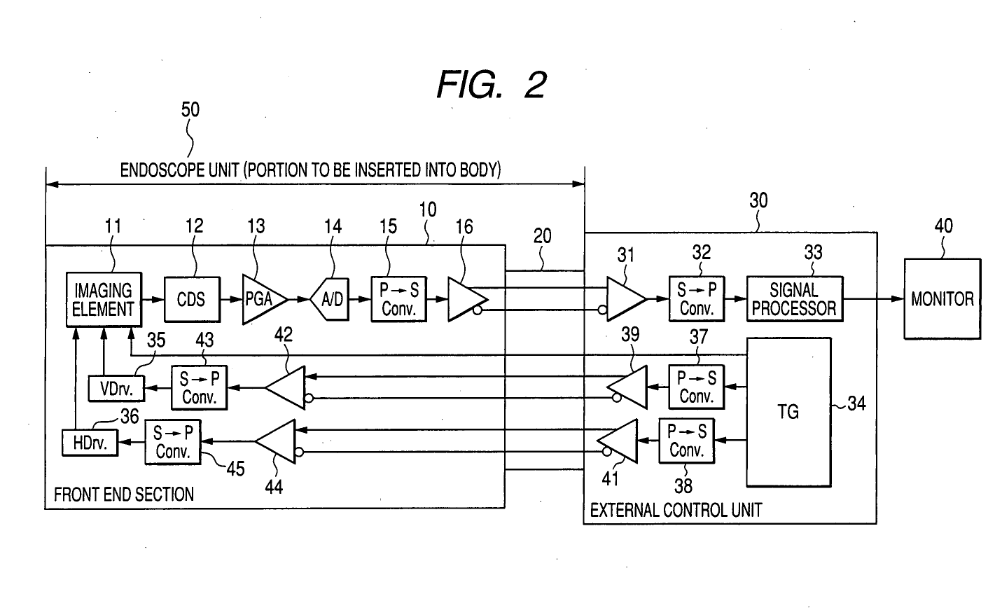

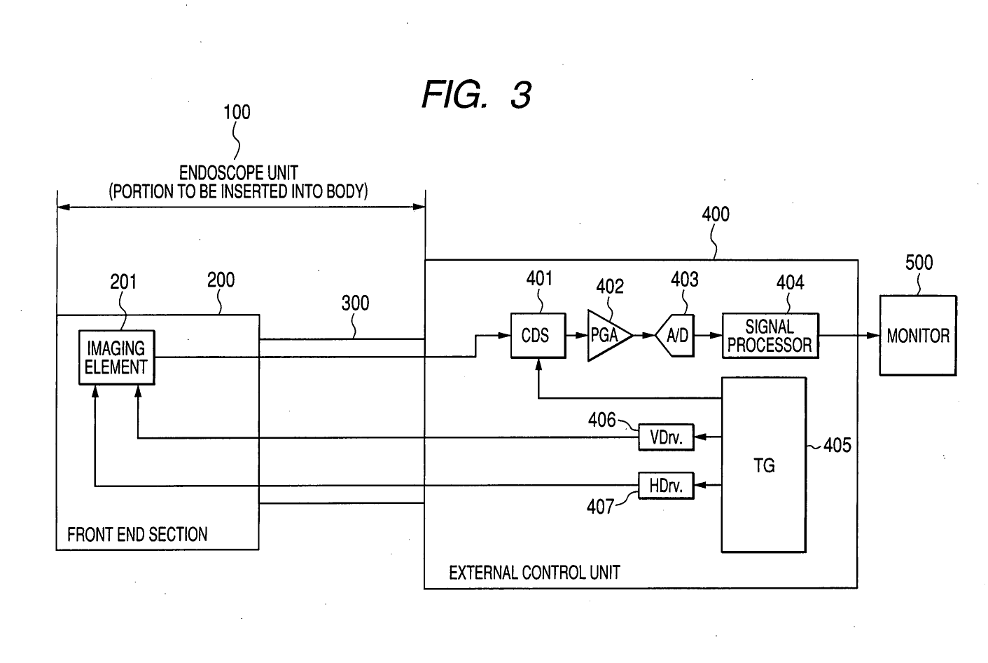

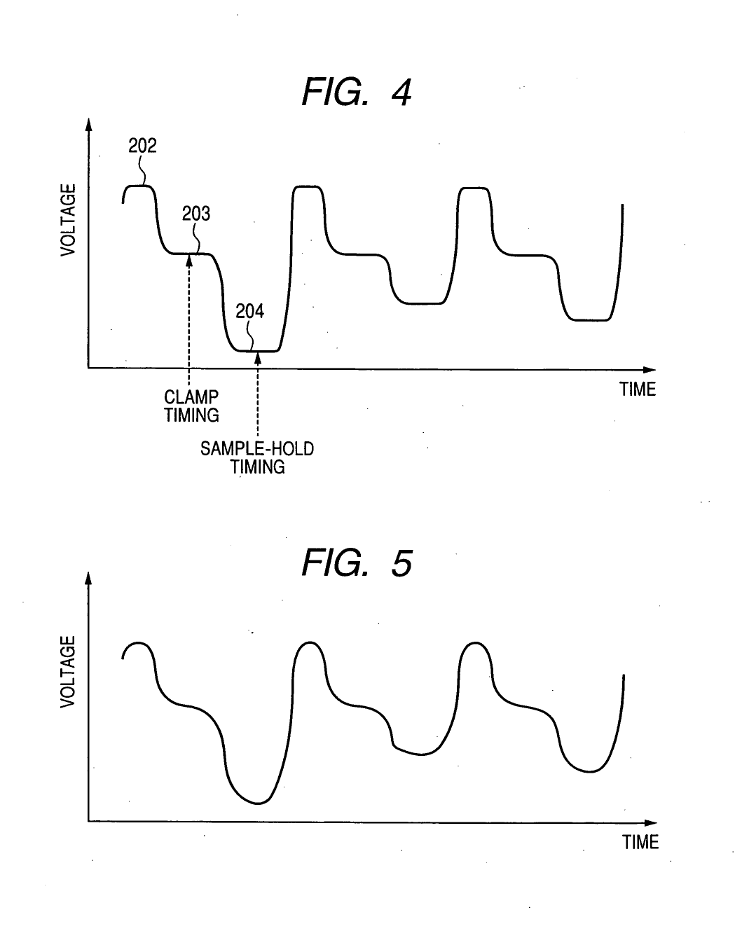

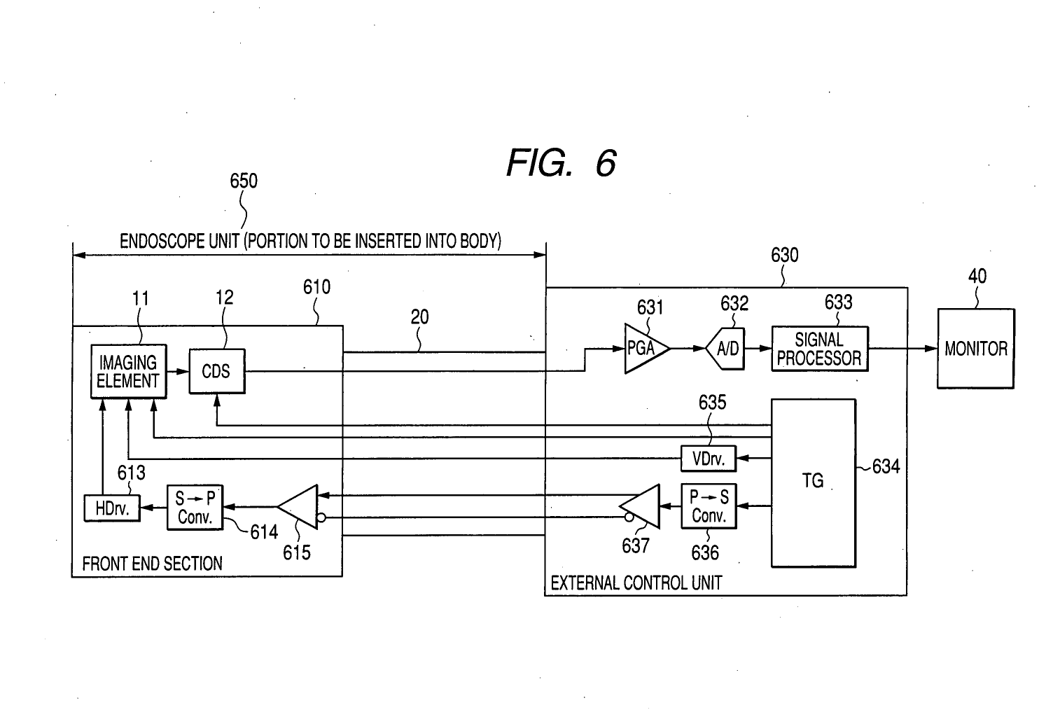

FIG. 2 is a view showing a schematic configuration of the endoscope according to a second embodiment. The same components shown in FIG. 2 as those in FIG. 1 will be denoted by the same reference numerals shown in FIG. 1.

The endoscope shown in FIG. 2 further includes the V driving section 35, the H driving section 36, serial/parallel (SP) converters 43 and 45, and receivers 42 and 44 in the front end section 10 shown in FIG. 1. Also, the endoscope shown in FIG. 2 further includes parallel/serial (PS) converters 37 and 38, and transmitters 39 and 41 instead of the V driving section 35 and the H driving section 36 in the external control unit 30 shown in FIG. 1.

A distance between the imaging element 11 and the V driving section 35 and a distance between the imaging element 11 and the H driving section 36 in the front end section 10 are sufficiently shorter than a length of the cable 20. The V driving section 35 and the H driving section 36 are disposed to be close to the imaging element 11.

The PS converter 37 converts the timing signals, which are to be parallel output from the TG 34 to the V driving section 35, into serial signals.

The transmitter 39 is connected to the receiver 42 of the front end section 10, and transmits the serial signals output from the PS converter 37 to the receiver 42 through a wire on the basis of the LVDS technology. When an impedance value of the receiver 42 is, for example, about 100Ω, it is possible to transmit a signal without deterioration of a signal quality, by using a single end cable of 50Ω or a twist bare wire of 100Ω for the wire.

The PS converter 38 converts the timing signals, which are to be parallel output from the TG 34 to the H driving section 36, into serial signals.

The transmitter 41 is connected to the receiver 44 of the front end section 10 through a wire, and transmits the serial signals output from the PS converter 38 to the receiver 44 through a wire on the basis of the LVDS technology. When an impedance value of the receiver 44 is, for example, about 100Ω, it is possible to transmit the signals without deterioration of signal quality, by using a single end cable of 50Ω or a twist bare wire of 100Ω for the wire.

The receiver 42 receives the serial signals transmitted from the transmitter 39 on the basis of the LVDS technology.

The SP converter 43 restores the timing signals, which are generated by the TG 34 and input to the PS converter 37, by converting the serial signals received by the receiver 42 into parallel signals.

The V driving section 35 drives the VCCD by inputting V driving signals of eight phases with a predetermined level to driving electrodes of the VCCD at a predetermined timing on the basis of the timing signals restored by the SP converter 43.

The receiver 44 receives the serial signals transmitted from the transmitter 41 on the basis of the LVDS technology.

The SP converter 45 restores the timing signals, which are generated by the TG 34 and input to the PS converter 38, by converting the serial signals received by the receiver 44 into parallel signals.

The H driving section 36 drives the HCCD by inputting H driving signals of four phases with a predetermined level to driving electrodes of the HCCD at a predetermined timing on the basis of the timing signals restored by the SP converter 45.

The CDS circuit 12, the PGA 13, the A/D converter 14, the PS converter 15, the transmitter 16, the V driving section 35, the H driving section 36, the SP converters 43 and 45, and the receivers 42 and 44 are integrated into the same silicon substrate in a form of an integrated IC (Integrated Circuit). Accordingly, decrease in size is realized. Since the V driving section 35 output voltages in a range of −8 V to 15V, the IC in the front end section 10 cannot be realized by a general CMOS process but it is necessary to process the IC by a high voltage-endurance CMOS process having a voltage endurance of 30 V or more. Accordingly, the IC in the front end section 10 is realized by a mixed process of the general CMOS process and the high voltage-endurance CMOS process.

The receiver 31, the SP converter 32, the TG 34, the PS converters 37 and 38, and the transmitters 39 and 41 are integrated into the same silicon substrate in a form of an integrated IC. The IC in the external control unit 30 is realized by the general CMOS process.

An operation of the endoscope with the above-described configuration will be described.

At the time of capturing an image, timing signals used to determine driving timings of the VCCD are converted into serial signals, and the serial signals are transmitted from the external control unit 30 to the front end section 10. Subsequently, the serial signals received by the receiver 42 of the front end section 10 are converted into parallel signals, and the V driving signals are input from the V driving section 35 to the imaging element 1 in accordance with the parallel signals. Also, timing signals used to determine driving timings of the HCCD are converted into serial signals, and the serial signals are transmitted from the external control unit 30 to the front end section 10. Subsequently, the serial signals received by the receiver 44 of the front end section 10 are converted into parallel signals, and the H driving signals are input from the H driving section 36 to the imaging element 11 in accordance with the parallel signals, By the V driving signals and the H driving signals, analog imaging signals corresponding to charges stored in the photoelectric conversion elements during an exposure are output from the imaging element. The following operations are the same as those in the first embodiment.

As described above, according to the endoscope having the configuration shown in FIG. 2, since the H driving section 36 is provided in the front end section 10 having the imaging element 11 therein, a distance between the imaging element 11 and the H driving section 36 can be made as short as possible. Accordingly, it is possible to minimize parasitic components existing in a transmission line between the imaging element 11 and the H driving section 36. Thus, it is possible to prevent a waveform of the H driving signals from being dull. As a result, it is possible to shorten a rising time and a falling time of the H driving signals in comparison with the case where the H driving section 36 is provided in the external control unit 30. Thus, it is possible to improve transmission efficiency.

Since the H driving signals output from the H driving section 36 are interlocked with the timing signals (a clamp pulse or a sample hold pulse) supplied to the CDS circuit 12, it is necessary to strictly manage the output timing. According to the configuration shown in FIG. 2, since the H driving section 36 is disposed considerably close to the imaging element 11, it is possible to suppress the output timing of the H driving signals from shifting. Thus, it is possible to perform the correlated-double sampling process in the CDS circuit 12 in an optimum manner.

According to the endoscope having the configuration shown in FIG. 2, since the V driving section 35 is provided in the front end section 10 having the imaging element 11 therein, a distance between the imaging element 11 and the V driving section 35 can be made as short as possible. Accordingly, it is possible to minimize parasitic components existing in a transmission line between the imaging element 11 and the V driving section 35. Thus, it is possible to prevent a waveform of the V driving signals from being dull. As a result, it is possible to shorten a rising time and a falling time of the V driving signals in comparison with the case where V driving section 35 is provided in the external control unit 30. Thus, it is possible to improve transmission efficiency.

Additionally, in the endoscope shown in FIG. 2, it is preferable that the V driving section 35 is provided in the external control unit 30 rather than in the front end section 10. That is because of the following reasons (1) to (3).

(1) The driving electrodes of the VCCD have capacitive loads of several 1,000 pF or so, which is much larger than the parasitic capacitance existing in a transmission line between the V driving section 35 and the VCCD. Therefore, the VCCD can be driven without an influence of the parasitic capacitance.

(2) The impedance value of the V driving section 35 when being turned on is about 60Ω and the parasitic resistance existing in a transmission line between the V driving section 35 and the VCCD is just several Ω at most. Therefore, the VCCD can be also driven without an influence of the parasitic capacitance.

(3) The V driving section 35 needs to be formed by a high voltage-endurance CMOS process. However, since a minimum width of a gate for acquiring a high voltage endurance property is larger than that of a general CMOS process, the circuit increases in size.

That is, even if the V driving section 35 is not provided in the front end section 10, the influence of the parasitic components existing in the transmission line is small. On the other hand, if the V driving section 35 is provided in the front end section 10, it may interfere with decreasing of the endoscope unit 50 in size. Accordingly, it is preferable that the V driving section 35 is provided in the external control unit 30. Meanwhile, the H driving section 36 is more influenced than the V driving section 35 by the parasitic components, and the size of its circuit is small. Accordingly, it is preferable that the H driving section 36 is provided in the front end section 10. In this way, by providing the H driving section 36 in the front end section 10 and providing the V driving section 35 in the external control unit 30, it is possible to obtain an endoscope as compact as possible without deterioration of the transmission efficiency.

In the case where the V driving section 35 is provided in the external control unit 30, the SP converter 43, the receiver 42, the transmitter 39, and the PS converter 37 may be omitted.

According to the endoscope having the configuration shown in FIG. 2, the timing signals input to the H driving section 36 are first converted into serial signals, and then are transmitted from the external control unit 30 to the front end section 10. Therefore, even when the number of timing signals to be supplied from the TG 34 to the H driving section 36 is any number, a wire housed in the cable 20 among wires for connecting the TG 34 to the H driving section 36 can be configured of two wires. Recently, since the number of driving signals of the HCCD increases, six electrodes or eight electrodes are widely used. Accordingly, the number of the timing signals is six or eight. However, even in such a case, it is possible to configure the wire for supplying the timing signals from the external control unit 30 to the H driving section 36 of the front end section 10 by two wires normally. Thus, it is possible to decrease a diameter of the cable.

According to the endoscope having the configuration shown in FIG. 2, the timing signals input to the V driving section 35 are first converted into the serial signals and then are transmitted from the external control unit 30 to the front end section 10. Therefore, the wires housed in the cable 20 among the wires for connecting the TG 34 to the V driving section 35 can be configured of two wires even when the number of the timing signals to be transmitted from the TG 34 to the V driving section 35 is any number. Accordingly it is possible to decrease a diameter of the cable 20 in that the number of the driving electrodes of the VCCD is more than that of the HCCD.

In the configuration shown in FIG. 2, in order to decrease a diameter of the cable 20, the SP converters 43 and 45, the receivers 42 and 44, the transmitters 39 and 41, and the PS converters 37 and 38 are provided. However, the SP converters 43 and 45, the receivers 42 and 44, the transmitters 39 and 41, and the PS converters 37 and 38 may be omitted as long as the thickness of the cable 20 is not concerned.

### Third Embodiment

FIG. 6 is a view showing a schematic configuration of the endoscope according to a third embodiment. The similar components in the third embodiment to those in the first and second embodiment will be denoted by the similar reference numerals in the first and second embodiments.

The endoscope shown in FIG. 6 includes an electronic endoscope unit 650 to be inserted in a body and an external control unit 630 for transmitting and receiving signals to and from the electric elements in the electronic endoscope unit 650. The electronic endoscope unit 650 is connected to the external control unit 630 through a connector (not shown).

The endoscope unit 650 includes a front end section 610 that has various electric elements such as an imaging element 11 formed in the front end thereof; and a cable 20 that is a housing portion that houses wires for connecting the electric elements in the front end section 610 to the external control unit 630. Normally, cables 20 having different lengths for respective sites to be observed are prepared, and the length of the cable 20 can be selected a site to be observed. The cable 20 houses an optical fiber for supplying light illuminating an observation object to the front end section 610.

The imaging element 11 includes a plurality of photoelectric conversion elements formed on a surface of a semiconductor substrate; a vertical charge transfer section (VCCD), which is disposed on respective sides of the plurality of photoelectric conversion elements and which transfers, in a vertical direction, charges generated in the plurality of photoelectric conversion elements; a horizontal charge transfer section (HCCD) for transferring the charges transferred by the VCCD in a horizontal direction perpendicular to the vertical direction; and an output amplifier for outputting signals on the basis of the charges transferred by the HCCD. The VCCD is driven by, for example, V driving signals of eight phases, and the HCCD is driven by H driving signals of plural phases (for example, four phases).

The front end section 610 includes the CDS circuit 12 for performing a correlated-double sampling process for analog imaging signals output from the imaging element 11; an H driving section 613 for driving the HCCD by inputting, to the HCCD, the H driving signals of four phases used to drive the HCCD of the imaging element 11; a receiver 615; and a serial/parallel (SP) converter 614.

A distance between the imaging element 11 and the CDS circuit 12 and a distance between the imaging element 11 and the H driving section 613 in the front end section 610 are sufficiently shorter than the length of the cable 20, respectively. The CDS circuit 12 and the H driving section 613 are disposed to be close to the imaging element 11.

In the CDS circuit 12, the output signals of the imaging element 11 are clamped and signal components containing image information are sampled and held. The clamp and the sample hold are carried out on the basis of the timing signals output from a TG 634. Noises in imaging signals are satisfactorily reduced by the correlated-double sampling process.

The external control unit 630 includes a PGA 631 for amplifying the output signals of the CODS circuit 12; an A/D converter 632 for converting the output signals of the PGA 631 into digital signals; and a signal process 633 for generating video data by performing signal processes, such as a γ correction process and a white balance adjusting process, for the digital signals subjected to the A/D conversion.

A video based on the video data generated by the signal processor 633 can be checked through a monitor 40 connected to the external control unit 630.

Also, the external control unit 630 includes a V driving section 635 for driving the VCCD by inputting, to the VCCD, V driving signals of eight phases used to drive the VCCD of the imaging element 11; the timing generator (TG) 634; a parallel/serial (PS) converter 636; and a transmitter 637.

The TG 634 generates timing signals used to determine operation timings of the CDS circuit 12, the V driving section 635, and the H driving section 613. Among the timing signals generated by the TG 634, four timing signals corresponding to the H driving signals of four phases, which are to be input from the H driving section 613 to the HCCD, are parallel output and then input to the H driving section 636. Among the timing signals generated by the TG 634, eight timing signals corresponding to the V driving signals of eight phases, which are to be input from the V driving section 635 to the VCCD, are parallel output and then input to the V driving section 635.

The PS converter 636 converts the four timing signals output from the TG 634 into serial signals and then inputs the serial signals to the transmitter 637.

The transmitter 637 is connected to a receiver 615 of the front end section 610 through a wire, and transmits the serial signals output from the PS converter 636 to the receiver 615 through the wire on the basis of an LVDS (Low Voltage Differential Signal) technology that is well known as a technology suitable for a long-distance transmission of digital signals. When an impedance value of the receiver 615 is, for example, about 100Ω, it is possible to transmit the signals without deterioration of signal quality, by using a single end cable of 50Ω or a twist bare wire of 100Ω for the wire.

The receiver 615 of the front end section 610 receives the serial signals transmitted from the transmitter 637 on the basis of the LVDS technology.

The SP converter 614 restores the four timing signals generated by the TG 634 and input to the PS converter 636 by converting the serial signals received by the receiver 615 into parallel signals.

The H driving section 613 drives the HCCD by inputting the H driving signals of four phases with a predetermined level to driving electrodes of the HCCD at a predetermined timing on the basis of the timing signals restored by the SP converter 614.

The CDS circuit 12, the H driving section 613, the SP converter 614, and the receiver 615 are all integrated into the same silicon substrate in a form of an IC (Integrated Circuit). Accordingly, it is possible to realize decrease in size of the front end section 610. The IC in the front end section 610 is realized by a general CMOS process.

The PGA 631, the A/D converter 632, the TG 634, the V driving section 635, the PS converter 636, and the transmitter 637 are integrated into the same silicon substrate in a form of an IC. Since the V driving section 635 output voltages in a range of −8 V to 15 V, the IC in the external control unit 630 is in the range of −8 V to 15 V, the IC cannot be realized by a general CMOS process but it is necessary to process the IC by a high voltage-endurance CMOS process having a voltage endurance of 30 V or more. Accordingly, the IC in the external control unit 630 is realized by a mixed process of the general CMOS process and the high voltage-endurance CMOS process.

An operation of the endoscope with the above-described configuration will be described.

At the time of capturing an image, the timing signals used to determine the driving timings of the VCCD are input to the V driving section 635, and the V driving signals are input from the V driving section 635 to the imaging element 11. Also, the timing signals used to determine the driving timings of the HCCD are converted into serial signals and then input to the front end section 610. The serial signals received by the front end section 610 are converted into parallel signals, and then the H driving signals are input from the H driving section 613 to the imaging element 11 in accordance with the parallel signals. By the V driving signals and the H driving signals, analog imaging signals corresponding to charges stored in the photoelectric conversion elements during an exposure are output from the imaging element 11. The imaging signals are subjected to the correlated-double sampling process by the CDS circuit 612, and then amplified by the PGA 631. Subsequently, the amplified imaging signals are converted into digital signals by the A/D converter 632, and then are subjected to various signals processes. Thereafter, an image based on the video data is displayed on the monitor 40.

According to the endoscope with the configuration shown in FIG. 6, since the CDS circuit 12 is provided in the front end section 610 having the imaging element 11 therein, a distance between the imaging element 11 and the CDS circuit 12 can be made as short as possible. Accordingly, it is possible to suppress the timing in the CDS circuit 12 for claiming the imaging signals and sampling and holding them from shifting. Thus, it is possible to perform the correlated-double sampling process in an optimum manner.

According to the endoscope with the configuration shown in FIG. 6, it is not necessary to increase a size of the H driving section 613 in order to prevent the waveform of H driving signals from being dull. As a result, it is possible to improve transmission efficiency without increasing an area of the endoscope and increasing power consumption.

In the third embodiment, the SP converter 614, the receiver 615, the transmitter 637, and the PS converter 636 are not necessary components, but the TG 634 may directly transmits the timing signals to the H driving section 613. According to the configuration shown in FIG. 6, it is possible to further decrease the diameter of the cable 20 of the electronic endoscope unit 50.

What is claimed is:

1. An endoscope comprising:
an electronic endoscope unit; and
an external control unit that transmits and receives a signal to and from the electronic endoscope unit, wherein
the electronic endoscope unit comprises
a front end section having an imaging element, and
a housing section that houses a wire that connects the front end section to the external control unit, and
the front end section comprises
a correlated-double sampling processor that performs a correlated-double sampling process for an analog signal output from the imaging element, and
an A/D converter that converts the analog signal to which the correlated-double sampling process is performed, into a digital signal.

2. The endoscope according to claim 1, wherein
the front end section further comprises
a first parallel/serial converter that converts parallel digital signals of plural bits output from the A/D converter into serial signals, and
a first transmitter that transmits the serial signals to the external control unit through the wire, and
the external control unit comprises
a first receiver that receives the serial signals transmitted from the first transmitter, and
a first serial/parallel converter that restores the digital signals after the A/D conversion by converting the serial signals received by the first receiver into parallel signals.

3. The endoscope according to claim 1, wherein
the imaging element comprises
a plurality of photoelectric conversion elements,
a vertical charge transfer section that transfers, in a vertical direction, charges generated in the plurality of photoelectric conversion elements, and
a horizontal charge transfer section that transfers the charges transferred by the vertical charge transfer section, in a horizontal direction perpendicular to the vertical direction, and
the front end section further comprises a horizontal driving unit that drives the horizontal charge transfer section by inputting, to the horizontal charge transfer section, horizontal driving signals of plural phases for driving the horizontal charge transfer section.

4. The endoscope according to claim 3, wherein the external control unit further comprises a vertical driving unit that drives the vertical charge transfer section by inputting, to the vertical charge transfer section, vertical driving signals for driving the vertical charge transfer section.

5. The endoscope according to claim 3, wherein
the external control unit comprises
a timing signal generator that generates a plurality of timing signals used to determine timings at which the horizontal driving unit outputs the horizontal driving signals of the plural phases,
a second parallel/serial converter that converts the plurality of parallel timing signals output from the timing signal generator into serial signals, and
a second transmitter that transmits the serial signals converted by the second parallel/serial converter, to the front end section through the wire,
the front end section further comprises
a second receiver that receives the serial signals transmitted from the second transmitter and
a second serial/parallel converter that restores the plurality of timing signals by converting the serial signals received by the second receiver into parallel signals, and
the horizontal driving unit outputs the horizontal driving signals in accordance with the plurality of restored timing signals.

6. The endoscope according to claim 1, wherein components of the front end section other than the imaging element are integrated on the same chip.

7. An endoscope comprising:
an electronic endoscope unit; and
an external control unit that transmits and receives a signal to and from the electronic endoscope unit, wherein
the electronic endoscope unit comprises
a front end section having an imaging element, and
a housing section that houses a wire that connects the front end section to
the external control unit,
the imaging element comprises
a plurality of photoelectric conversion elements,
a vertical charge transfer section that transfers, in a vertical direction, charges generated in the plurality of photoelectric conversion elements, and
a horizontal charge transfer section that transfers the charges transferred by the vertical charge transfer section in a horizontal direction perpendicular to the vertical direction,
the front end section comprises
a correlated-double sampling processor that performs a correlated-double sampling process for an analog signal output from the imaging element, and
a horizontal driving unit that drives the horizontal charge transfer section by inputting, to the horizontal charge transfer section, horizontal driving signals of plural phases for driving the horizontal charge transfer section, and
the external control unit comprises a vertical driving unit that drives the vertical charge transfer section by inputting, to the vertical charge transfer section through the wire, vertical driving signals for driving the vertical charge transfer section.

8. The endoscope according to claim 7, wherein
the external control unit further comprises
a timing signal generator that generates a plurality of parallel timing signals used to determine timings at which the horizontal driving unit outputs the horizontal driving signals of the plural phases,
a parallel/serial converter that converts the plurality of parallel timing signals into serial signals, and
a transmitter that transmits the serial signals to the front end section through the wire,
the front end section further comprises
a receiver that receives the serial signals transmitted from the transmitter, and
a serial/parallel converter that restores the plurality of timing signals by converting the serial signals received by the receiver into parallel signals, and
the horizontal driving unit outputs the horizontal driving signals in accordance with the plurality of restored timing signals.

9. The endoscope according to claim 7, wherein components of the front end section other than the imaging element are integrated on the same chip.
